(19) United States
(12) Patent Application Publication
(10) Pub. No.: US 2024/0102722 A1
(43) Pub. Date: Mar. 28, 2024

(54) HEAT PUMP

(71) Applicant: VIESSMANN CLIMATE SOLUTIONS SE, Allendorf (DE)

(72) Inventors: Thorsten SCHMIDT, Marburg (DE); Eduard LANG, Allendorf (DE)

(73) Assignee: VIESSMANN CLIMATE SOLUTIONS SE, Allendorf (DE)

(21) Appl. No.: 18/276,504

(22) PCT Filed: Feb. 1, 2022
(86) PCT No.: PCT/DE2022/100087

§ 371 Date: Aug. 9, 2023

(30) Foreign Application Priority Data
Feb. 10, 2021 (DE) 10 2021 103 063.3

(51) Int. Cl. F25D 23/00; F25B 30/02

(52) U.S. Cl. CPC F25D 23/006; F25B 30/02

(57) ABSTRACT

A heat pump includes a compressor for compressing a coolant and a further heat pump component through which the coolant flows, the compressor being designed to be connected to the further heat pump component in order to convey the coolant via fluid lines, and the compressor and the further heat pump component being designed to be connected to a housing of the heat pump via spring elements in order to reduce transmission of structure-borne sound. The compressor and the further heat pump component are designed to be firmly connected to one another exclusively, on the one hand, via the fluid lines which connect them and, on the other hand, via the spring elements connected to the housing of the heat pump.

The invention relates to a heat pump according to the preamble of patent claim 1.

A heat pump of the above-mentioned type is known from the document DE 10 2018 115 749 A1. This heat pump consists of a compressor for compressing a coolant and a further heat pump component, through which the coolant flows, wherein the compressor is formed to be connected to the further heat pump component in order to convey the coolant via fluid lines, and wherein the compressor and the further heat pump component are formed to be connected to a housing of the heat pump via spring elements in order to reduce a transmission of structure-borne sound. In the case of this solution, the compressor and the further heat pump component are arranged on a common carrying element.

The invention is based on the object of further improving a heat pump of the above-mentioned type. In particular, a heat pump comprising a compressor, which is decoupled even better, is to be created.

This object is solved with a heat pump of the above-mentioned type by means of the features listed in the characterizing part of patent claim 1.

According to the invention, it is thus provided that, on the one hand, the compressor and the further heat pump component are formed to be firmly connected to one another exclusively via the fluid lines connecting them and, on the other hand, via the spring elements connected to the housing of the heat pump.

In other words, the solution according to the invention is thus characterized in that the compressor and the further heat pump component are connected to one another as little as possible, in order to suppress a transmission of structure-borne sound as far as possible or as much as possible, respectively. The used requirement “firmly connected” thereby means that, in addition to the mentioned connections and in spite of the requirement “exclusively”, a further connection is possible, for example, via an electrical line, a rubber hose, or the like because such a connection, which is basically very resilient, is to not be considered to be a firm, structure-borne sound-transmitting connection.

Other advantageous further developments of the heat pump according to the invention follow from the dependent patent claims.

The heat pump according to the invention, including its advantageous further developments according to the dependent patent claims will be described in more detail below on the basis of the graphic illustration of a preferred exemplary embodiment, in which

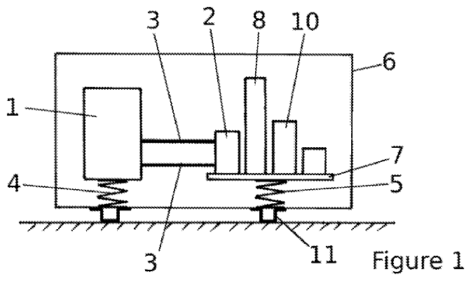

FIG. 1 shows the heat pump according to the invention comprising a decoupled compressor in schematic view;

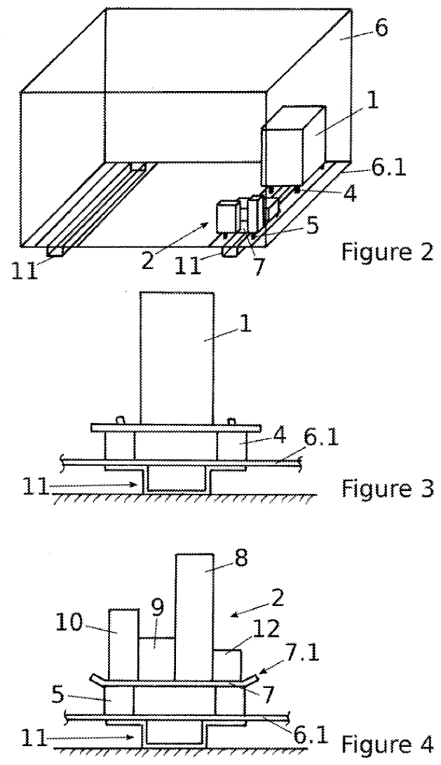

FIG. 2 a heat pump comprising a carrying element for the heat pump components in a perspective view;

FIG. 3 shows the compressor of the heat pump according to FIG. 1 positioned on a load transfer element in side view;

FIG. 4 shows the carrying element positioned on a load transfer element comprising the heat pump components of the heat pump according to FIG. 2 in side view;

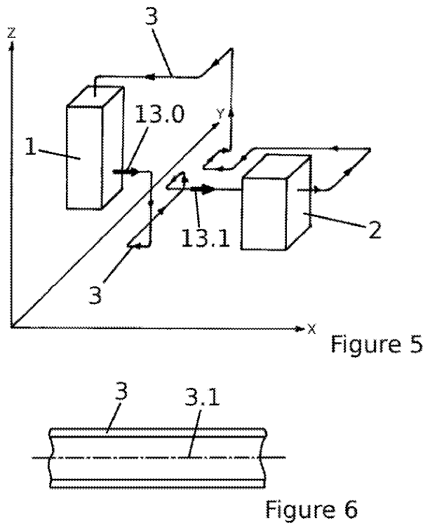

FIG. 5 shows a heat pump comprising a fluid line wound in all directions between the compressor and a heat pump component in schematic view;

FIG. 6 shows a section through the fluid line according to FIG. 5; and

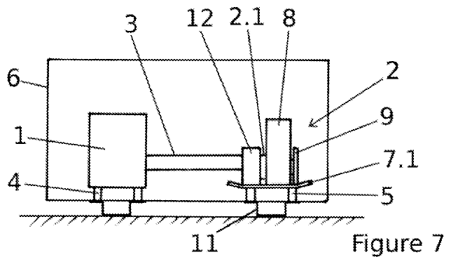

FIG. 7 shows a heat pump comprising a unit, which is formed like a rigid body, consisting of carrying element and heat pump components, in schematic view.

The heat pump illustrated in FIG. 1 consists, in a known manner, of a compressor 1 for compressing a coolant, and a further heat pump component 2, through which the coolant flows, wherein the compressor 1 is formed to be connected to the further heat pump component 2 in order to convey the coolant via fluid lines 3, and wherein the compressor 1 and the further heat pump component 2 are formed to be connected to a housing 6 of the heat pump via spring elements 4, 5 in order to reduce a transmission of structure-borne sound.

It is thereby preferably provided that the spring elements 4, 5, which are only illustrated schematically in FIG. 1, are (in fact) at least partially made of an elastomer, in particular polyurethane foam, thus as resilient insulating elements.

It is further preferably provided that a first fluid line 3 is formed as coolant supply line to the compressor 1 and a second fluid line 3 as coolant discharge line from the compressor 1.

It is furthermore preferably provided that the fluid lines 3 are optionally made of a material with a stiffness comparable to a metallic material and/or of a metallic material. In the case of the solution according to the invention, the fluid lines 3 thus in particular do not consist of a plastic or rubber material.

It is now essential for the heat pump according to the invention that, on the one hand, the compressor 1 and the further heat pump component 2 are formed to be firmly connected to one another exclusively via the fluid lines 3 connecting them and, on the other hand, via the spring elements 4, 5, which are connected to the housing 6 of the heat pump. As described above, this requirement leads to a particularly good decoupling of the compressor from the other heat pump components and thus to a very low-noise heat pump.

Examined even more closely, it is particularly preferably provided that the further heat pump component 2 is formed as valve means, in particular as multi-way valve.

It is furthermore particularly preferably provided that the further heat pump component 2 is positioned on a carrying element 7. It is thereby furthermore preferably provided that the carrying element 7 is formed to be connected to the housing 6 of the heat pump via the spring elements 5. It is further also preferably provided that further heat pump components of the heat pump, such as a heat exchanger 8, an expansion means 9 and/or a coolant accumulator 10, are positioned on the carrying element 7. These further, passive heat pump components (because they do not produce vibrations themselves) thereby advantageously form an integrated assembly on the carrying element 7, as can be seen, which is ultimately stimulated to vibrate only via the fluid lines 3.

What is furthermore preferably provided:

The heat pump illustrated in FIGS. 2 to 4 consists of the housing 6, at least one load transfer element 11 arranged on an underside 6.1 of the housing 6, the compressor 1 arranged in the housing 6 perpendicularly above the load transfer element 11, and further heat pump components 2, which are likewise arranged in the housing 6, wherein a resilient insulating element (spring element 4) is arranged between the compressor 1 and the load transfer element 11.

In the case of this heat pump, it is preferred that several heat pump components 2 are positioned on the common carrying element 7, which is arranged perpendicularly above a load transfer element 11, wherein a further resilient insulating element (spring element 5) is arranged between the carrying element 7 and the load transfer element 11.

It is preferred thereby that the underside 6.1 of the housing 6 is made of a sheet metal arranged between the load transfer element 11 and the resilient insulating element (or the resilient insulating elements, respectively), see FIGS. 3 and 4. It is furthermore preferred that the resilient insulating element is at least partially made of an elastomer, preferably of polyurethane foam. It is additionally preferred that the compressor 1 is formed to be connected to the load transfer element 11 via at least three resilient insulating elements (which are preferably arranged on the corners of an imaginary triangle).

It is furthermore preferred that two load transfer elements 11 are arranged on the underside 6.1 of the housing 6, preferably parallel to one another. The load transfer element 11 is likewise preferably formed to be at least three times, preferably six times, particularly preferably eight times longer than wide or high, respectively, and/or the load transfer element 11 is preferably formed as profile rail made of sheet metal. It is additionally preferred that the compressor 1 and the carrying element 7 are assigned to the same load transfer element 11, see FIG. 2.

It is additionally preferred that a heat exchanger 8, preferably a plate heat exchanger, an expansion means 9, a valve means 12 and/or a coolant accumulator 10 are or is optionally arranged, respectively, on the carrying element 7, see FIG. 4. It is likewise preferred that the carrying element 7 is formed in a plate-shaped manner, preferably of sheet metal. The plate-shaped carrying element 7 is thereby formed so as to be provided with chamfers 7.1 on the edge side. This serves the purpose of reinforcing the carrying element 7 and promotes the rigid body vibration behavior of the heat pump. It is furthermore preferred that the heat pump components 2 are arranged so as to be fastened to the carrying element 7. The carrying element 7 is further preferably and except for the contact via the bases resulting from the arrangement above the load transfer element 11 moreover formed so as to be connected in a fixation-free manner to the load transfer element 11. This passive block thus ultimately simply stands on the load transfer element 11, wherein a lateral displacement is ruled out in particular simply due to the piping to the compressor 1.

In its above-described embodiments, the heat pump illustrated in FIGS. 2 to 4 thus has a rigid body behavior, which leads to a good insulation of the low-frequency vibrations generated by the heat pump components 2 and in particular the compressor 1. The noise exposure is significantly reduced thereby by means of the heat pump.

The heat pump illustrated schematically in FIG. 5 consists of a compressor 1, which is formed to be connected via two coolant-conveying fluid lines 3 to the heat pump component 2, through which the coolant flows, wherein each fluid line 3 has a longitudinal axis 3.1 (see FIG. 6 with regard to this), wherein an imaginary direction vector 13.1, which coincides with the longitudinal axis 3.1, in the course between the compressor 1 and the heat pump component 2, points at least once in a different direction than an imaginary initial direction vector 13.0, which starts at the compressor 1 and likewise coincides there with the longitudinal axis 3.1, wherein the longitudinal axis 3.1 is formed so as run in a space with three imaginary planes XY, XZ, YZ, which are perpendicular to one another.

In order to suppress a vibration transmission from the compressor 1, which preferably comprises an electric motor, to the at least one heat pump component 2 as much as possible, it is now preferably provided that the fluid line 3 is shaped so that in the course between the compressor 1 and the heat pump component 2 and with regard to all three planes XY, XZ, YZ, the direction vector 13.1 is formed so as to run being rotated at least once about an angle of 180° to the initial direction vector 4.0.

As a whole, this requirement leads to an increase of the resilience or decrease of the stiffness, respectively, of the fluid line between the compressor and the heat pump component and thus to a reduced vibration transmission.

The fluid line 3 is furthermore preferably made of a metallic material. If applicable, plastic can preferably also be considered. However, the more resilient the actually used material of the fluid line per se, the less it logically requires the approach shown in FIGS. 5 and 6.

In order to realize a flow of the coolant, which is as undisturbed as possible, through the fluid line 3, it is further preferably provided that said fluid line is formed to be continuously curved on all of its curved regions. The term “continuously” is meant mathematically thereby. In other words, it is to thus be provided that the fluid line 3 does not have any sharp-edged bends. The changes in direction of the fluid line 3 are therefore illustrated in a rounded manner in FIG. 5.

It is furthermore preferably provided that in the course between the compressor 1 and the heat pump component 2, the fluid line 3 is formed so as to be at least partially conveyed optionally around the compressor 1 and/or the heat pump component 2. This requirement, which further contributes to the reduction of a vibration transmission, applies for the fluid line 3, which leads from the heat pump component 2 to the compressor 1 (as clarified by the corresponding arrows).

As mentioned above, it is lastly particularly preferably provided that the deflection of the fluid line 3 does not only take place by at least 180°, but preferably by at least 270°. Particularly preferably, it is provided that the fluid line 3 is shaped so that in the course between the compressor 1 and the heat pump component 2 and with regard to one of the three planes XY, XZ, YZ, the direction vector 13.1 is formed to perform a complete 360° turn compared to the initial direction vector 13.0. In FIG. 5, both illustrated fluid lines 3 fulfill exactly this requirement.

The heat pump illustrated in FIG. 7 initially consists, in a known manner, of a compressor 1, which operates within an operational speed range and which thereby causes at least an interference frequency of the first order, for compressing a coolant and further heat pump components 2, which are arranged on the carrying element 7 and through which the coolant likewise flows.

Examined more closely, it is preferably provided that at least one heat exchanger 8, a valve means 12 and/or an expansion means 9 are optionally arranged on the carrying element 7.

It is furthermore preferably provided that a unit consisting of the carrying element 7 and the heat pump components 2 arranged thereon has a first natural frequency, which is greater than the interference frequency of the first order, which is transmitted by the compressor 1 operating in the operational speed range to the unit acting in a rigid body-like manner.

It is thereby particularly preferably provided that the compressor 1 has an operational speed range from 700 to 7200 revolutions per minute, particularly preferably from 800 to 6900 revolutions per minute, more preferably from 900 to 6600 revolutions per minute.

It is additionally particularly preferably provided that the unit consisting of the carrying element 7 and the heat pump components 2 arranged thereon has a first natural frequency of more than 100 Hz, particularly preferably of more than 120 Hz, most preferably of more than 140 Hz.

In order to work towards the above-mentioned condition, it is furthermore particularly preferably provided that the carrying element 7 (already!) has a first natural frequency, which is greater than the interference frequency of the first order caused by the compressor 1 operating in the operational speed range.

In order to work even further towards the above-mentioned condition, it is furthermore particularly preferably provided that each heat pump component 2 has a first natural frequency, which is greater than the interference frequency of the first order, which is caused by the compressor 1 operating in the operational speed range.

In the event that due to a corresponding material selection of a piping 2.1 of the heat pump components 2, there is likewise a need to act, it is furthermore particularly preferably provided that the unit, including the piping 2.1 of the heat pump components 2, has a first natural frequency, which is greater than the interference frequency of the first order, which is transmitted by the compressor 1 operating in the operational speed range to the unit, which acts in a rigid body-like manner.

In other words, it is thus preferably provided that a coupled natural frequency of the entire unit is basically determined on the basis of the local natural frequencies of the individual components or is designed so that it lies above the interference frequency of the first order of the compressor 1, respectively.

In order to increase the local natural frequency, as illustrated in FIG. 7, it is thus also provided, for example, that the carrying element 7 is formed as plate comprising a chamfer 7.1 in order to increase its natural frequency (as already specified above with regard to the heat pump according to FIGS. 2 to 4). It can furthermore preferably be provided that the carrying element 7 is formed to be thicker than is required for the actual load.

As can be seen from FIG. 7, it is furthermore preferably provided that the compressor 1 is formed to be fastened to the housing 6 of the heat pump via one (typically—and as illustrated—several) resilient insulating element(s) (spring element(s) 4). In a similar way, it is further preferably provided that the carrying element 7 is formed to be fastened to the housing 6 of the heat pump via one (or several) resilient insulating element(s) (spring element(s) 5).

It is thereby furthermore particularly preferably provided that the resilient insulating element is at least partially made of an elastomer, preferably of polyurethane foam.

It is furthermore preferably provided that the compressor 1 and the unit, except for required fluid lines 3 between the compressor 1 and the unit, are formed to be able to vibrate independently of one another.

In order to ensure an even load on the insulating element (or on the insulating elements, respectively) arranged on the carrying element 7, it is lastly particularly preferably provided that a center of gravity of the unit—due to suitable arrangement of the heat pump components 2—is selected so that a perpendicular introduction of gravitational force into the insulating element (or into the insulating elements, respectively) results.

### LIST OF REFERENCE NUMERALS

1 compressor
2 heat pump component
2.1 piping
3 fluid line
3.1 longitudinal axis
4 spring element
5 spring element
6 housing
6.1 underside
7 carrying element
7.1 chamfer
8 heat exchanger
9 expansion means
10 coolant accumulator
11 load transfer element
12 valve means
13.0 initial direction vector
13.1 direction vector
XY plane, perpendicularly to XZ and YZ
XZ plane, perpendicularly to XY and YZ
YZ plane, perpendicularly to XY and XZ

1: A heat pump, comprising a compressor (1) for compressing a coolant, and a further heat pump component (2), through which the coolant flows, wherein the compressor (1) is formed to be connected to the further heat pump component (2) in order to convey the coolant via fluid lines (3), and wherein the compressor (1) and the further heat pump component (2) are formed to be connected to a housing (6) of the heat pump via spring elements (4, 5) in order to reduce a transmission of structure-borne sound,
wherein, on the one hand, the compressor (1) and the further heat pump component (2) are formed to be firmly connected to one another exclusively via the fluid lines (3) connecting them and, on the other hand, via the spring elements (4, 5) connected to the housing (6) of the heat pump.

2: The heat pump according to claim 1,
wherein the further heat pump component (2) is formed as valve means, in particular as multi-way valve.

3: The heat pump according to claim 1 or 2,
wherein the spring elements (4, 5) are at least partially made of an elastomer.

4: The heat pump according to claim 1,
wherein the further heat pump component (2) is positioned on a carrying element (7).

5: The heat pump according to claim 4,
that wherein the carrying element (7) is formed to be connected to the housing (6) of the heat pump via the spring elements (5).

6: The heat pump according to claim 4,
wherein further heat pump components of the heat pump, such as a condenser (8), an expansion means (9) and/or a coolant accumulator (10), are positioned on the carrying element (7).

7: The heat pump according to claim 1,
wherein a first fluid line (3) is formed as coolant supply line to the compressor (1) and a second fluid line (3) as coolant discharge line from the compressor (1).

8: The heat pump according to claim 1,
wherein the fluid lines (3) are made of a material with a stiffness comparable to a metallic material.

9: The heat pump according to claim 1,
wherein the fluid lines (3) are made of a metallic material.
